(19) United States
(12) Patent Application Publication
(10) Pub. No.: US 2007/0095479 A1
(43) Pub. Date: May 3, 2007

(54) Device for permanently joining at least two components, comprising at least one power source

(76) Inventor: Martin Koepsell, Oldenburg (DE)

Correspondence Address: WILLIAM COLLARD;COLLARD & ROE, P.C., 1077 NORTHERN BOULEVARD, ROSLYN, NY, 11576, US

(21) Appl. No.: 11/590,197

(22) Filed: Oct. 31, 2006

(30) Foreign Application Priority Data
Nov. 2, 2005 (DE) DE 102005052241.6

(51) Int. Cl. B32B 37/00

(52) U.S. Cl. 156/379.6

(57) ABSTRACT

The invention relates to a device for permanently joining at least two components, comprising at least one power source for providing energy to bring about the joint.

The invention relates to a device for permanently joining at least to components, comprising at least one power source for providing energy to bring about the joint.

Permanent joints are fabricated by soldering or welding, for example. The permanency of the joints is achieved by sectionally heating, and hence liquefying, the components to be joined together, so that the materials of both components can enter into an intermeshing joint once the components cool again. The power source is used for heating purposes.

Known in addition to electrical welding is laser welding. The advantage of laser welding in comparison to heating element welding and other types of welding is that no mechanical stress is placed on the components, and that the locally limited heat input provides for a nearly wear-free procedure. Welding takes place without contact, and materials with varying viscosities can be joined together.

However, the disadvantage to laser welding is that a laser device is needed, which is cost-intensive. In addition, special safety measures must be met when using laser beams, in order to ensure the safety of persons working in proximity to the device.

The object of the invention is to indicate a device of the type specified at the outset, with which the advantages of laser welding can be realized in a cost-effective manner.

This object is achieved according to the invention by virtue of the fact that the power source is a light-emitter diode (LED).

Hence, the device according to the invention has no complicated and expensive laser device, but rather at least one light-emitter diode. A light-emitter diode is advantageous, a high level of power is not required for its operation. The use of light-emitter diodes requires less stringent protective measures than the use of laser beams, while the light-emitter diode simultaneously allows the contactless joining of at least two components, namely via welding. A small, locally limited heat input takes place, preferably by way of several light-emitter diodes. No mechanical stress is placed on the components.

The components are joined by converting radiation energy into thermal energy via the absorption of radiation energy in the material of the components. This gives rise to a locally limited melt in a joining area.

One further development of the invention here provides that the light-emitter diode be connected with the joining area of the components via an optical cable by at least one optical waveguide system. The optical system guides the light generated by the light-emitter diodes in the joining area of the components, introducing the light into the latter. In this case, the optical waveguide system distributes the light to convert the punctiform light source LED into a uniformly illuminated surface. This yields a cost-effective, simultaneous welding of an entire seam, and the necessary process time is lowered in comparison to conventional solutions with laser devices.

In order to achieve a rigid bond between the components, suitable materials must be selected for the components. In one further development of the invention, the components to be joined together are fabricated out of the same or different plastics. The plastics can be technical polymers. It is possible to incorporate additives into the plastics to produce color plastics that look identical to the human eye, but still exhibit a different absorptive behavior. For example, at least one of the components to be joined can be transparent, and at least one of the components to be joined can be opaque. Light from the light-emitter diodes is then aimed at the transparent component, through which the light passes, and then hits the opaque component. This radiation procedure known from laser welding is also made possible in LED welding with the device according to the invention. However, only a power of about 3 to 10 watts is here required for a light-emitter diode.

To further expound upon the invention, it is provided that the optical waveguide system encompass a focusing unit, which is arranged in front of the area in which the components are joined viewed in the optical cable direction. This focusing unit causes light in the joining area to be focused on the absorbing plastic material.

The optical waveguide system can here consist of optical cables made of PMMA, PC and similar plastics. The optical cable or optical waveguide system is preferably made out of glass to avert losses, and hence heating at undesired locations. In addition, glass can be molded or machined, thereby providing a high level of design freedom for the optical waveguide system.

In another structural configuration, a further development of the invention proposes that the device have a mount for the components to be joined together, and that this mount be framed by light-emitter diodes as the power sources. In terms of structural design, then, several light-emitter diodes are used. These are arranged like a frame, so as to encompass the joining area of the two components. The joining area can here also be shaped as a frame, e.g., as a continuous weld seam for two components to be joined together. The light-emitter diodes arranged like a frame makes it possible to produce a frame-like weld seam by operating these light-emitter diodes simultaneously. The light form these light-emitter diodes is introduced via the optical waveguide system into the entire joining area simultaneously. In this case, the optical system ensures that the light is uniformly introduced into the joining area. The light from the light-emitter diodes here exhibits an identical wavelength, similarly to a laser, and the optical waveguide system also achieves a coherence resembling that of a laser.

To further expound upon the invention, it is finally provided that the weld seam connect a cap with a receptacle for an electronic component, preferably for a microswitch. The joining force required for the welding process is here achieved by an overlapping configuration for the components to be joined.

The drawing shows one exemplary embodiment of the invention from which other inventive features derive. Shown on:

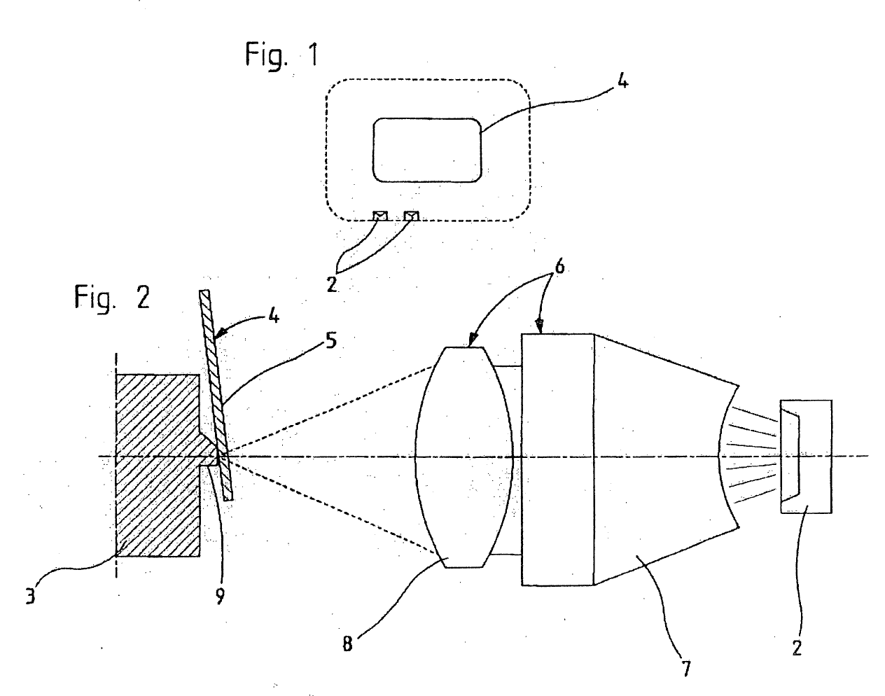

FIG. 1 is a diagrammatic top view of the device according to the invention, and

FIG. 2 is a partial side view of the device according to FIG. 1.

FIG. 1 shows a device according to the invention for permanently joining two components. This figure shows a top view of one component, the slip-on cap 4, and the components are also shown on FIG. 2. The slip-on cap 4 on FIG. 1 is held in a mount, wherein it is enveloped by a plurality of light-emitter diodes 2 in the shape of a frame. The light sent out by the light-emitter diodes 2 is simultaneously routed to the mount, and components located on this mount can be welded together with this light.

FIG. 2 shows the receptacle 3 for a microswitch and slip-on cap 4 for this microswitch. A light-emitter diode 2 is allocated to a transparent section of the cap wall 5 shown on FIG. 2. Situated between the light-emitter diode 2 and cap wall 5 is an optical waveguide system 6, which comprises an optical cable 7 and a focusing unit 8. The optical waveguide system 6 is arranged at a defined distance from the cap wall 5 and the surface of the receptacle 3, which corresponds to the focal distance of the focusing unit 8 designed as a lens. The several light-emitter diodes 2 on FIG. 1 are arranged in a circulating contour, in which each optical waveguide system 6 allocated to a light-emitter diode 2 is arranged at an optimal distance to the surface of the components to be joined together.

The surface of the receptacle 3 facing the cap wall exhibits a projection 9. The cap wall 5 abuts this projection 9 under a prestress, with the abutment simultaneously serving as the joining area for both components. The light from the light-emitter diode 2 is focused in this area. Focusing takes place over the entire circumference of the receptacle 3 and slip-on cap 4. FIG. 1 only shows the slip-on cap 4, which slides over the receptacle 3. Welding the receptacle 3 and slip-on cap 4 establishes a tight joint between the two components, which is impervious to air and liquid. In this case, joining is accomplished using the LED welding process, and other joining methods, such as mechanical latching or adhesive bonding, need not be used.

1. A device for permanently joining at least two components, comprising at least one power source for providing energy to bring about the joint, wherein the power source is a light-emitter diode (LED) (2).

2. The device according to claim 1, wherein the light-emitter diode (2) is connected with the joining area of the components by optical cable via at least one optical waveguide system (6).

3. The device according to claim 1, wherein the components to be joined together are made out of the same or different plastics.

4. The device according to claim 3, wherein the light-emitter diode (2) has a power consumption of about 3 W to 10 W.

5. The device according to claim 1, wherein least one of the components to be joined is transparent, and at least one of the components to be joined is opaque.

6. The device according to claim 2, wherein the optical waveguide system (6) comprises a focusing unit (8), which is arranged in front of the area in which the components are joined viewed in the optical cable direction.

7. The device according to claim 6, wherein the optical waveguide system (6) has a glass optical cable (7).

8. The device according to claim 1, wherein it has a mount for the components to be joined together, and that this mount is framed by light-emitter diodes (2) as the power sources.

9. The device according to claim 8, wherein a frame-like weld seam can be produced with the light-emitter diodes (2) arranged like a frame.

10. The device according to claim 9, wherein the weld seam connects a cap (4) with a receptacle (3) for an electronic component, preferably for a microswitch.
